(19) United States
(12) Patent Application Publication
(10) Pub. No.: US 2023/0308708 A1
(43) Pub. Date: Sep. 28, 2023

(54) SYSTEMS AND METHODS FOR CONTROLLING A USER INTERFACE FOR PRESENTATION OF LIVE MEDIA STREAMS

(71) Applicants: Donde Fashion, Inc., Wilmington, DE (US); Shopify Inc., Ottawa (CA)

(72) Inventors: Kshetrajna Raghavan, Fremont, CA (US); Roni Gurvich, Ramat Gan (IL)

(21) Appl. No.: 17/704,523

(22) Filed: Mar. 25, 2022

(51) Int. Cl. H04N 21/431; H04N 21/439; H04N 21/44; H04N 21/2187

(52) U.S. Cl. CPC H04N 21/4316; H04N 21/4394; H04N 21/44008; H04N 21/2187

(57) ABSTRACT

A computer-implemented is disclosed. The method includes: obtaining video data and audio data for a live media stream; detecting a first product in at least one video frame of the live media stream, the first product being one of a first set of defined objects associated with the live media stream; identify one or more keywords in speech detected in the audio data, the one or more keywords being included in a second set of defined terms associated with the live media stream; determining a product variant of the first product based on the detected one or more keywords; and providing, for display via a client device associated with a viewer of the live media stream, an interactive user interface element associated with a first action in connection with the product variant.

### FIELD

The present disclosure relates to media streaming technologies and, in particular, to systems and methods for controlling a user interface associated with presentation of live media streams.

### BACKGROUND

Livestreaming is a popular form of distributing media content to large audiences. A wide variety of content, such as social media, interactive gameplay, and news coverage, may be simultaneously recorded and broadcast using a livestream service. A live media stream may be initiated by a broadcaster, either spontaneously or in accordance with a defined schedule. Livestreaming typically requires source media (e.g., video camera, audio interface, etc.), encoders to digitize the content, a media publisher entity, and a content delivery network for distributing the content to viewers. Livestream content can be consumed using various different user interfaces (e.g., web browser, dedicated mobile app, etc.) on computing devices.

### BRIEF DESCRIPTION OF THE DRAWINGS

Embodiments will be described, by way of example only, with reference to the accompanying figures wherein:

FIG. 1 illustrates an example system for processing live media streams, including a streaming media management engine;

FIG. 2 is a block diagram of an e-commerce platform that is configured for implementing example embodiments of the streaming media management engine of FIG. 1;

FIG. 3 shows, in flowchart form, an example method of controlling a user interface for presenting a live media stream on viewer devices;

FIG. 4 shows, in flowchart form, an example method for detecting objects in video data associated with a live media stream;

FIG. 5 shows, in flowchart form, another example method of controlling a user interface for presenting a live media stream on viewer devices;

FIG. 6 shows, in flowchart form, another example method of controlling a user interface for presenting a live media stream on viewer devices;

FIG. 7 is a block diagram of an e-commerce platform, in accordance with an example embodiment; and

FIG. 8 is an example of a home page of an administrator, in accordance with an example embodiment.

### DETAILED DESCRIPTION OF EMBODIMENTS

In an aspect, the present application discloses a computer-implemented method. The method includes: obtaining video data and audio data for a live media stream; detecting a first product in at least one video frame of the live media stream, the first product being one of a first set of defined objects associated with the live media stream; identify one or more keywords in speech detected in the audio data, the one or more keywords being included in a second set of defined terms associated with the live media stream; determining a product variant of the first product based on the detected one or more keywords; and providing, for display via a client device associated with a viewer of the live media stream, an interactive user interface element associated with a first action in connection with the product variant.

In some implementations, detecting the first product in the at least one video frame may include processing video frames of the live media stream using a machine learning model.

In some implementations, the machine learning model may be trained using a few-shot learning technique.

In some implementations, the second set of defined terms may include a plurality of product descriptors of products.

In some implementations, determining a product variant of the first product may include: determining a candidate set of product variant candidates associated with the first product; and filtering the candidate set using the detected one or more keywords.

In some implementations, providing the interactive user interface element associated with the first action may include: generating display data associated with the user interface element; and transmitting the display data to the client device associated with the viewer.

In some implementations, providing the interactive user interface element associated with the first action may include at least one of: updating a graphical representation of the user interface element; or changing a redirect link that is associated with the user interface element to a new link associated with the product variant.

In some implementations, identifying the one or more keywords may include: obtaining a speech-to-text transcription of the speech detected in the audio data; and identifying the one or more keywords in the speech-to-text transcription.

In some implementations, the first action may be at least one of: adding the product variant to an online shopping cart associated with the viewer; processing a purchase of the product variant; redirecting to a product page associated with the product variant; or electronically sharing product data for the product variant.

In some implementations, providing the interactive user interface element may include causing the user interface element to be overlayed on top of the live video at a first time associated with the at least one video frame.

In another aspect, the present application discloses a computing system. The computing system includes a processor and a memory storing computer-executable instructions that, when executed, configure the processor to: obtain video data and audio data for a live media stream; detect a first product in at least one video frame of the live media stream, the first product being one of a first set of defined objects associated with the live media stream; identify one or more keywords in speech detected in the audio data, the one or more keywords being included in a second set of defined terms associated with the live media stream; determine a product variant of the first product based on the detected one or more keywords; and provide, for display via a client device associated with a viewer of the live media stream, an interactive user interface (UI) element associated with a first action in connection with the product variant.

In another aspect, the present application discloses a non-transitory, computer-readable medium storing computer-executable instructions that, when executed by a processor, configure the processor to carry out at least some of the operations of a method described herein.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

In the present application, the term “product data” refers generally to data associated with products that are offered for sale on an e-commerce platform. The product data for a product may include, without limitation, product specification, product category, manufacturer information, pricing details, stock availability, inventory location(s), expected delivery time, shipping rates, and tax and tariff information. While some product data may include static information (e.g., manufacturer name, product dimensions, etc.), other product data may be modified by a merchant on the e-commerce platform. For example, the offer price of a product may be varied by the merchant at any time. In particular, the merchant may set the product's offer price to a specific value and update said offer price as desired. Once an order is placed for the product at a certain price by a customer, the merchant commits to pricing; that is, the product price may not be changed for the placed order. Product data that a merchant may control (e.g., change, update, etc.) will be referred to as variable product data. More specifically, variable product data refers to product data that may be changed automatically or at the discretion of the merchant offering the product.

In the present application, the term “e-commerce platform” refers broadly to a computerized system (or service, platform, etc.) that facilitates commercial transactions, namely buying and selling activities over a computer network (e.g., Internet). An e-commerce platform may, for example, be a free-standing online store, a social network, a social media platform, and the like. Customers can initiate transactions, and any associated payment requests, via an e-commerce platform, and the e-commerce platform may be equipped with transaction/payment processing components or delegate such processing activities to one or more third-party services. An e-commerce platform may be extendible by connecting one or more additional sales channels representing platforms where products can be sold. In particular, the sales channels may themselves be e-commerce platforms, such as Facebook Shops™, Amazon™, etc.

### Live Media Streaming

Various livestream services facilitate “live selling”. With live selling, products are showcased in a live social broadcast that enables audience members to interact with the streamer and with each other in real-time. For example, a streamer may promote a product (e.g., a sponsored product) by showcasing it in a live media stream and describing features of the product to the audience. Audience members may comment or ask questions (via live chat) about the featured product during the stream, and the streamer and/or a merchant may respond in real-time.

In an online sales channel, customers are typically presented with product information and various purchasing options for a product. For example, a social media advertisement for a product may include a photo that is manually tagged with a link to a product detail page or a link to an in-app checkout. Tagging a live media stream with product information or purchase options is much more challenging, at least because (1) multiple different products may be featured in the stream concurrently or within a short span of time, and (2) product appearances in the stream typically occur in a spontaneous manner. Livestream platforms are thus limited in their capacity to provide relevant product information in real-time during a live media stream and as a result, viewers may be required to independently query information about any featured products. For example, upon seeing a product of interest in a live media stream, a viewer may need to note any information (e.g., name, description, etc.) gathered from the live media stream about the product and either exit the streaming user interface or wait until the end of the live media stream to manually initiate a product search using the gathered information. Consequently, the viewer may lose context for the product query and miss out on interactivity (e.g., asking product-related questions, etc.) in connection to the featured products during the live media stream. Moreover, the streaming platform may not directly provide information about the featured product(s) or if it does, the information may be statically or persistently presented such that it is difficult for a viewer to associate the presented information to different products that are shown throughout the live media stream.

The present application discloses solutions for addressing some of the aforementioned technical limitations of conventional livestreaming systems. Specifically, a system for dynamically presenting product purchase options during a live media stream is proposed. The disclosed system combines video object detection and speech processing to identify, in real-time, products that are featured in a live media stream. The system is configured to automatically present user interface elements associated with the identified products to the live media stream audience. By way of example, the system may automatically generate and display user interface elements that allow viewers of a live media stream to purchase products that are showcased during the live media stream.

The system receives and processes a source video stream to identify one or more featured product(s). A machine learning model is employed for identifying products in the video. In at least some embodiments, a machine learning model trained with few-shot learning (FSL) techniques may be used. First, a group of products to be featured in a live media stream is selected (e.g., from a merchant's catalogue). For each of the selected products, product images are obtained. The machine learning model is trained on a training dataset comprising product images for a plurality of products. The trained model is used to extract embeddings of the selected products and store them in a data structure that enables efficient search, e.g., an index. The trained model creates vector representations of product images and builds embedding spaces. Vectors having the smallest distance between them, as measured by a suitable metric (e.g., Euclidean distance, etc.), may be grouped together. In this way, product images of the same product may be vectorized and stored in the same embedding space. A given product may thus be mapped to a specific embedding space.

When parsing video frames of the live media stream, the index is used to search embeddings that are matching to the one(s) extracted from a current video frame. In particular, the machine learning model may be configured to vectorize the input frames and determine, for each input vector, the closest embedding space and by consequence, the particular product associated with the embedding space.

The system is configured to process the video data and audio data of the live media stream in parallel. In particular, the system may perform speech recognition in conjunction with video data analysis in order to identify products that are featured in a live media stream. In at least some embodiments, the system may perform keyword spotting in connection with recognized speech associated with the live media stream. A streamer may specify one or more keywords, such as product descriptors (e.g., size, color, etc.), in advance of the stream. Additionally, or alternatively, the system may store a set of common product descriptors and keywords may be automatically detected by the system by identifying product descriptors in the transcription of the streamer's speech.

In some embodiments, the recognized speech may be used to determine a variant of a product that is detected by the video data analysis. Specifically, keywords in the streamer's speech may be determined to be product descriptors and said descriptors may be used to narrow down the product variant (i.e., filter a set of product variant candidates) that is featured and/or described in the live media stream. For example, when multiple variants of a given product exist, a streamer may mention details that are descriptive of a specific variant during the live media stream and the descriptors used by the streamer may be recognized as one or more of the predetermined keywords, thereby facilitating identification of a product variant.

Upon identifying a product and/or a specific variant of a product, the system is configured to generate and display user interface elements associated with the product/variant. In particular, the system may generate one or more user interface elements associated with certain purchase actions (e.g., “Buy now”, “Add to cart”, etc.), connect the user interface elements with corresponding redirect links, and provide the user interface elements for display in a graphical user interface on a device of a stream viewer. In some embodiments, user interface elements that are (persistently) displayed in a live media stream interface may be updated with parameters that are relevant to the product/variant that is currently being featured in the live media stream. For example, an interactive user interface element may be dynamically updated with a different label, redirect link, etc., as different products are showcased during the live media stream.

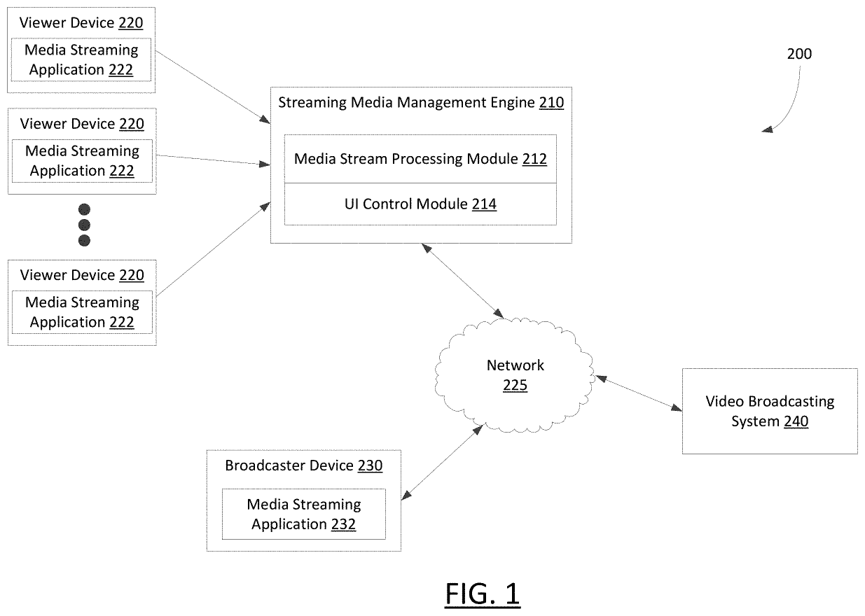

Reference is now made to FIG. 1, which illustrates, in block diagram form, an example system 200 for processing live media streams. As shown in FIG. 1, the system 200 may include viewer devices 220, broadcaster devices 230, a video broadcasting system 240, and a network 225 connecting one or more of the components of system 200.

As illustrated, the viewer devices 220 and the broadcaster device 230 communicate via the network 225. In at least some embodiments, each of the viewer devices 220 and the broadcaster device 230 may be a computing device. The viewer devices 220 and the broadcaster device 230 may take a variety of forms including, for example, a mobile communication device such as a smartphone, a tablet computer, a wearable computer (such as a head-mounted display or smartwatch), a laptop or desktop computer, or a computing device of another type.

The broadcaster device 230 is associated with a broadcaster. In particular, the broadcaster device 230 enables a broadcaster to initiate streaming of media content to one or more viewers. In at least some embodiments, the broadcaster device 230 may have resident thereon a media streaming application 232. The media streaming application 232 may be a standalone application (e.g., a mobile app) or a web-based application. A broadcaster can launch the media streaming application 232 on the broadcaster device 230 and initiate a live media (e.g., audio, video, etc.) stream. The live media stream may be transmitted directly to viewer devices 220. Alternatively, the live media stream may be transmitted to an intermediary video broadcasting system 240. In some embodiments, the video broadcasting system 240 may be a social networking system, and the media streaming application 232 may be a social networking application for gaining access to a social network. The broadcaster device 230 may communicate with servers of the video broadcasting system 240 via the media streaming application 232. The video broadcasting system 240 may, in turn, transmit the live media stream to viewer devices 220. The media streaming application 232 may include various monitoring and management functionalities involved in producing a live media stream. By way of example, the broadcaster may control transmission settings for a live media stream, manage viewer permissions, and monitor audience reactions using the media streaming application 232.

The viewer devices 220 are associated with viewers of a live media stream. Viewers may access a live media stream using a media streaming application 222, which may be standalone application or a web-based application. For example, live media streams may be viewed using a web browser, a social networking application, a media playback application, or the like. Viewer devices 220 may communicate directly with the broadcaster device 230, or they may communicate with servers of a video broadcasting system 240.

The video broadcasting system 240 provides a platform for sharing content by means of streams of video data, including live media streams. The video broadcasting system 240 may comprise servers that are configured to receive and transmit live media streams. In at least some embodiments, the video broadcasting system 240 may be a social networking system. In particular, the video broadcasting system 240 may be a computing system that can host an online social network. Users may access the social network to broadcast content to other users or to view content that is steamed by other users. For example, the video broadcasting system 240 may provide a website or software (e.g., a social media app) that enables users to initiate or view a live media stream. The video broadcasting system 240 receives digitally encoded data representing live media streams from broadcaster devices 230, and viewer devices 220 access servers of the video broadcasting system 240 to receive transmission of the encoded video stream data.

A streaming media management engine 210 is provided in the system 200. The streaming media management engine 210 may be a software-implemented module containing processor-executable instructions that, when executed by one or more processors, cause a computing system to carry out some of the processes and functions described herein. In some embodiments, the streaming media management engine 210 may be provided as a stand-alone service. In particular, a computing system may engage the streaming media management engine 210 as a service that facilitates processing of live media streams.

The streaming media management engine 210 is configured to receive audio and video data for live media streams. In particular, the streaming media management engine 210 may be communicably connected to one or more broadcaster devices 230. For example, the broadcaster device 230 may transmit live media stream data directly to the streaming media management engine 210, or live media stream data may be received at the streaming media management engine 210 via an intermediary system, such as the video broadcasting system 240.

In accordance with one or more disclosed embodiments, the streaming media management engine 210 may facilitate customization of live media streams for individual viewers. For example, the streaming media management engine 210 may transmit modified versions of an original live media stream to viewer devices. That is, the media (e.g., audio, video, etc.) data of the live media stream may be modified by the streaming media management engine 210 prior to transmission to viewers. Additionally, or alternatively, the streaming media management engine 210 may transmit the original stream with instructions on how to modify the stream on the client-side (i.e., at the viewer device) prior to presenting the stream to a viewer. For example, the streaming media management engine 210 may be configured to provide customized overlay content that is transmitted with an original live media stream to viewer devices.

By way of further example, the streaming media management engine 210 may be configured to provide instructions for controlling the user interfaces through which live media streams are presented. Specifically, customized instructions for controlling different types of user interfaces (e.g., web browser, mobile streaming application, social media application, etc.) for livestreaming may be generated by the streaming media management engine 210 (or components thereof) for transmission, either directly or via a third-party server/system, to viewer devices 220. In particular, the instructions may be stream-specific; that is, the instructions relate to a specific live media stream and thus enable control of user interfaces during presentation (either live or playback) of said live media stream. Suitable applications on the viewer devices 220 can process the instructions in order to control the associated user interfaces, for example, when presenting the relevant live media stream.

The streaming media management engine 210 includes a media stream processing module 212. The media stream processing module 212 performs operations for processing the media data associated with live media streams. The media stream processing module 212 may receive live video feed from various sources (e.g., video mixers, broadcaster devices, etc.). The live video feed may be in a compressed or uncompressed format. The media stream processing module 212 may supply the live video feed to a plurality of video encoders that compress the live video feed using one or more codecs (e.g., MPEG-2, H. 264, etc.).

The media stream processing module 212 may perform analysis of the media content associated with a live video feed. In some embodiments, the media stream processing module 212 may perform object detection in the live media stream. In particular, the media stream processing module 212 may implement detection of objects (e.g., persons, physical objects, etc.) and associated features and actions, in real-time, based on analysis of video data of the live media stream. The media stream processing module 212 may, for example, include an objection detection sub-module.

In some embodiments, the media stream processing module 212 may implement a speech recognition function. In particular, the media stream processing module 212 may include a speech recognition sub-module that is configured to automatically recognize and translate spoken language into text. For example, the media stream processing module 212 may detect uttered keywords of subjects (e.g., a streamer) that are featured in a live media stream.

The streaming media management engine 210 also includes a user interface control module 214. The user interface control module 214 is configured to generate instructions for managing user interfaces of programs, applications, and the like, which may be used to access a live media stream. In particular, the user interface control module 214 may provide instructions for dynamically updating the graphical user interface of a media streaming application 222 on a viewer device 220 and/or a media streaming application 232 on a broadcaster device 230. For example, the user interface control module 214 may provide, to viewer devices, instructions for controlling the display and functionalities of user interface elements on a graphical user interface during presentation of live media streams.

The streaming media management engine 210, the viewer devices 220, the broadcaster device 230, and the video broadcasting system 240 may be in geographically disparate locations. Put differently, the viewer devices 220 may be remote from one or more of: streaming media management engine 210, the broadcaster device 230, and the video broadcasting system 240. As described above, the viewer devices 220, the broadcaster device 230, the streaming media management engine 210, and the video broadcasting system 240 may be computing systems.

The network 225 is a computer network. In some embodiments, the network 225 may be an internetwork such as may be formed of one or more interconnected computer networks. For example, the network 225 may be or may include an Ethernet network, an asynchronous transfer mode (ATM) network, a wireless network, or the like.

In some example embodiments, the streaming media management engine 210 may be integrated as a component of an e-commerce platform. That is, an e-commerce platform may be configured to implement example embodiments of the streaming media management engine 210. More particularly, the subject matter of the present application, including example methods for controlling a user interface for presentation of live media streams disclosed herein, may be employed in the specific context of e-commerce.

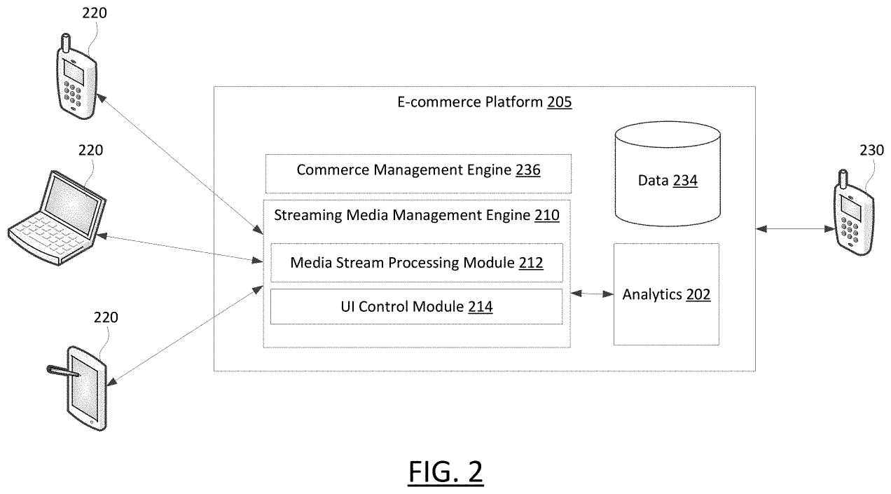

Reference is made to FIG. 2 which illustrates an example embodiment of an e-commerce platform 205 that implements a streaming media management engine 210. The viewer devices 220 and the broadcaster device 230 may be communicably connected to the e-commerce platform 205. In at least some embodiments, the viewer devices 220 and the broadcaster device 230 may be associated with accounts of the e-commerce platform 205. More specifically, the viewer devices 220 and the broadcaster device 230 may be associated with entities (e.g., individuals) that have accounts in connection with the e-commerce platform 205. For example, one or more viewer devices 220 and broadcaster device 230 may be associated with customers (e.g., customers having e-commerce accounts) or merchants having one or more online stores in the e-commerce platform 205. The e-commerce platform 205 may store indications of associations between viewer/broadcaster devices and merchants or customers of the e-commerce platform, for example, in the data facility 134.

The e-commerce platform 205 includes a commerce management engine 236, a streaming media management engine 210, a data facility 234, and a data store 202 for analytics relating to streaming media. The commerce management engine 236 may be configured to handle various operations in connection with e-commerce accounts that are associated with the e-commerce platform 205. For example, the commerce management engine 236 may be configured to retrieve e-commerce account information for various entities (e.g., merchants, customers, etc.) and historical account data, such as transaction events data, browsing history data, and the like, for selected e-commerce accounts. In particular, the commerce management engine 236 may obtain account information for e-commerce accounts of viewers and/or broadcasters of live media streams that are associated with the e-commerce platform 205.

The functionality described herein may be used in commerce to provide improved customer or buyer experiences. The e-commerce platform 205 may implement the functionality for any of a variety of different applications, examples of which are described herein. Although the streaming media management engine 210 of FIG. 2 is illustrated as a distinct component of the e-commerce platform 205, this is only an example. An engine could also or instead be provided by another component residing within or external to the e-commerce platform 205. In some embodiments, one or more applications that are associated with the e-commerce platform 205 may provide an engine that implements the functionality described herein to make it available to customers and/or to merchants. Furthermore, in some embodiments, the commerce management engine 236 may provide that engine. However, the location of the streaming media management engine 210 may be implementation specific. In some implementations, the streaming media management engine 210 may be provided at least in part by an e-commerce platform, either as a core function of the e-commerce platform or as an application or service supported by or communicating with the e-commerce platform. Alternatively, the streaming media management engine 210 may be implemented as a stand-alone service to clients such as a customer device or a merchant device. In addition, at least a portion of such an engine could be implemented in the merchant device and/or in the customer device. For example, a customer device could store and run an engine locally as a software application.

The streaming media management engine 210 is configured to implement at least some of the functionality described herein. Although the embodiments described below may be implemented in association with an e-commerce platform, such as (but not limited to) the e-commerce platform 205, the embodiments described below are not limited to e-commerce platforms.

In some embodiments, the streaming media management engine 210 may allow for associating a live media stream with e-commerce accounts that are associated with the e-commerce platform 205. For example, the streaming media management engine 210 may determine that a broadcaster of a live media stream is associated with a merchant of the e-commerce platform 205. The broadcaster may themselves be a seller (e.g., a gamer selling gameplay-related merchandise, a social media influencer selling branded products, etc.), the broadcaster may specify a merchant for whom content is streamed (e.g., a social media influencer showcasing a product of a merchant sponsor), or a merchant can specify a broadcaster for whom approval is granted to feature their product in a live media stream. The streaming media management engine 210 may associate the live media stream with the merchant. As another example, the streaming media management engine 210 may determine that one or more viewers of a live media stream are associated with customer accounts on the e-commerce platform 205. The streaming media management engine 210 may associate the live media stream with e-commerce accounts of those customers that view the live media stream.

In at least some embodiments, the user interface control module 214 cooperates with the media stream processing module 212 to facilitate control of user interfaces associated with programs/applications on viewer devices for accessing live media streams. The user interface control module 214 may be configured to provide, to viewer devices, instructions for controlling the display and functionalities of various user interface elements in connection with a live media stream. As will be described in greater detail below, the instructions for controlling user interface elements may be generated based on object detection of products and/or product variants in video data associated with a live media stream independently or in combination with recognition of uttered speech in audio data associated with the live media stream.

The data facility 234 may store data collected by the e-commerce platform 205 based on the interaction of merchants and customers with the e-commerce platform 205. For example, merchants provide data through their online sales activity. Examples of merchant data for a merchant include, without limitation, merchant identifying information, product data for products offered for sale, online store settings, geographical regions of sales activity, historical sales data, and inventory locations. Customer data, or data which is based on the interaction of customers and prospective purchasers with the e-commerce platform 205, may also be collected and stored in the data facility 234. Such customer data is obtained on the basis of inputs received via customer devices associated with the customers and/or prospective purchasers. By way of example, historical transaction events data including details of purchase transaction events by customers on the e-commerce platform 205 may be recorded and such transaction events data may be considered customer data. Such transaction events data may indicate product identifiers, date/time of purchase, final sale price, purchaser information (including geographical region of customer), and payment method details, among others. Other data vis-à-vis the use of e-commerce platform 205 by merchants and customers (or prospective purchasers) may be collected and stored in the data facility 234.

The data facility 234 may include customer preference data for customers of the e-commerce platform 205. For example, the data facility 234 may store account information, order history, browsing history, and the like, for each customer having an account associated with the e-commerce platform 205. The data facility 234 may additionally store, for a plurality of e-commerce accounts, wish list data and cart content data for one or more virtual shopping carts.

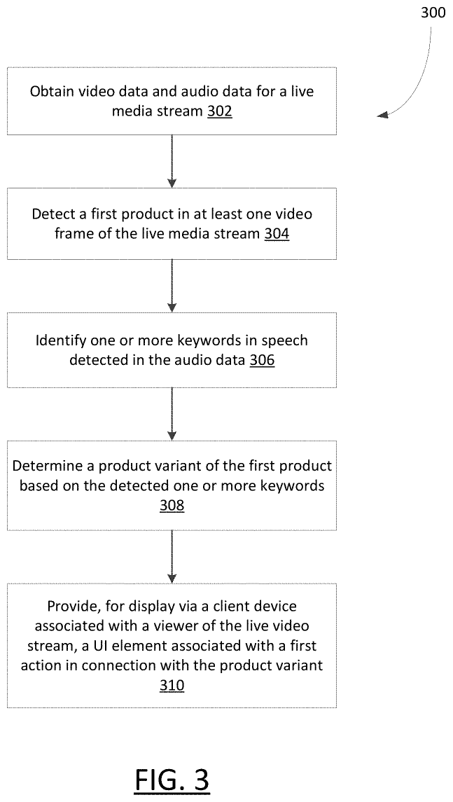

Reference is now made to FIG. 3, which shows, in flowchart form, an example method 300 of controlling a user interface for presenting a live media stream on viewer devices. The method 300 may be performed by a computing system that implements media stream processing, such as the streaming media management engine 210 of FIG. 1. As detailed above, the streaming media management engine may be a service that is provided within or external to an e-commerce platform to facilitate, among others, control of user interfaces for media streaming that are accessed on viewer devices. The streaming media management engine may generate control instructions for transmission to viewer devices in accordance with the method 300.

In operation 302, the streaming media management engine obtains video data and audio data associated with a live media stream. The live media stream data may be transmitted by a computing device associated with a broadcaster. In some embodiments, the video and audio data may be transmitted directly from the broadcaster device to the streaming media management engine. Alternatively, the streaming media management engine may receive the video and audio data from a video broadcasting system, such as the servers of an online social network. The live media stream may be broadcast by a user of the social network, and the video and audio data may be transmitted from the social network servers for delivery to viewer devices associated with other users of the social network.

The streaming media management engine receives the video and audio data prior to delivery of the live media stream to viewers. That is, for one or more viewers of a live media stream, i.e., viewers that request to access a live media stream, the streaming media management engine may process the video and audio data of the live media stream prior to delivery of the stream content to the viewers. In particular, the streaming media management engine is configured to receive and process original video and audio data for a live media stream in real-time.

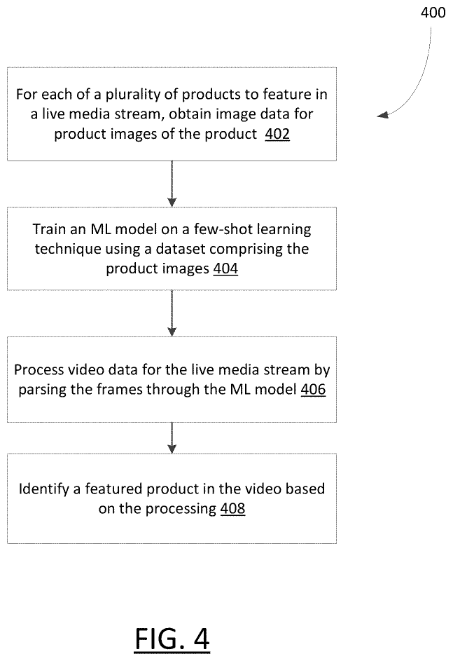

In operation 304, the streaming media management engine detects a first product in at least one video frame of the live media stream. Specifically, the streaming media management engine processes video frames of video associated with the live media stream and performs object detection in the video frames. The video frames may be processed using a machine learning model. That is, the streaming media management engine may implement a suitable machine learning model for video object detection. In at least some embodiments, a machine learning model trained using a few-shot learning technique may be employed in performing the video object detection. The video object detection will be described in greater detail below with reference to FIG. 4.

The first product may be one of a predefined set of products (i.e., objects) that are used for training the relevant machine learning model. In particular, the first product may be a specific item in a catalogue of a merchant that is associated with the live media stream. The product data for the merchant's catalogue may be stored, for example, in a product database that is accessible by the streaming media management engine.

Once the first product has been identified based on video analysis of the live media stream, the streaming media management engine processes audio data associated with the live media stream and performs speech recognition based on the audio data. Specifically, the streaming media management engine identifies one or more keywords in speech detected in the audio data, in operation 306. The keywords are words that are included in a set of defined terms associated with the live media stream. That is, the streaming media management engine may store or have access to a definition of terms which may be used in keyword recognition, i.e., identifying keywords in utterances of the speaker. In at least some embodiments, the defined terms may include product descriptors of various different types of products. Examples of product descriptors include terms that are commonly used to describe variable attributes of products, such as size, color, shapes, etc., and labels that are indicative of level or quality of product (e.g., standard, premium, deluxe, etc.).

The streaming media management engine may adapt one or more of various techniques for keyword detection, such as a matching algorithm based on dynamic time warping (DTW) or embedded learning, a time delay neural network, and a trained large-vocabulary continuous speech recognition (LVCSR) system.

The keywords detected are those instances of one or more of the defined terms in audio segments that are temporally proximate to the video frame(s) in which the first product is detected. In particular, the streaming media management engine is configured to detect instances of the keywords in audio segments that immediately precede or follow the points in the live media stream at which the streaming media management engine detects the first product in the video data. In at least some embodiments, the streaming media management engine may first verify that the audio and video of the live media stream are synchronized. Upon confirming audio-to-video synchronization, the streaming media management engine may process only the audio segments corresponding to video segments that are associated with a time period either immediately preceding or following the timestamps of video frame(s) in which the first product is detected. The time period may, for example, be a predefined threshold length of time. Only the keywords detected in these select audio segments may be used for further processing, i.e., identification of a specific variant of the first product.

In some embodiments, the streaming media management engine may obtain, in real-time, speech-to-text transcription of the speech detected in the audio data. For example, the streaming media management engine may itself perform speech-to-text conversion of the streamer's utterances and identify the keywords based on text analysis of the transcription.

Upon recognition of keywords based on the audio data of the live media stream, the streaming media management engine determines a product variant of the first product based on the detected keywords, in operation 308. In at least some embodiments, the streaming media management engine may select from a plurality of candidate product variants. Specifically, the streaming media management engine may determine a candidate set of product variants associated with the first product and filter the candidate set using the detected keywords. That is, the recognized keywords are used in filtering product data to identify a specific variant of a product that is detected in the video analysis.

In operation 310, the streaming media management engine provides, for display via a client device associated with a viewer of the live media stream (i.e., viewer device), at least one interactive user interface element associated with a first action in connection with the product variant. In at least some embodiments, the streaming media management engine may be configured to generate display data associated with the at least one interactive user interface element. For example, the display data may include images, labels, text, and the like, for indicating the product, the identified specific variant of the product, and/or the first action associated with a user interface element. The first action may be a user interaction relating to the identified product variant and may include, for example: adding the product variant to an online shopping cart associated with the viewer; processing a purchase of the product variant; redirecting to a product page associated with the product variant; or electronically sharing product data for the product variant. The display data can then be transmitted to viewer devices for display thereon.

In some embodiments, the streaming media management engine may generate instructions for controlling one or more user interface elements associated with the live media stream. In particular, rather than providing display data associated with user interface elements to viewer devices, the streaming media management engine may only transmit control instructions which can subsequently be processed at a viewer device for generating, displaying, and updating user interface elements thereon.

Reference is now made to FIG. 4, which shows, in flowchart form, an example method 400 for detecting objects in video data associated with a live media stream. The method 400 may be performed by a computing system that implements media stream processing, such as the streaming media management engine 210 of FIG. 1. The operations of method 400 may be performed as part (i.e., as sub-methods) of operation 304 of method 300.

As previously mentioned, the techniques disclosed herein may employ trained machine learning models for performing video object detection. In some embodiments, a machine learning model trained on few-shot learning may be used. Few-shot learning is a type of machine learning method where the training dataset contains a limited number of samples. Unlike image classification models which require training on large datasets, few-shot learning models may be able to make fairly accurate predictions even if the model has not been exposed to a large amount of training data. In particular, the few-shot learning technique lends itself well to the applications of image classification and object recognition where the training dataset only contains a small number of sample images.

To take advantage of a model trained on few-shot learning techniques, an initial set of products from a merchant's catalogue to be featured in live media streams is identified. That is, one or more specific products which may be shown during a live media stream are identified. The streaming media management engine then obtains image data for product images of the products, in operation 402. In particular, at least one image sample for each of the identified products (i.e., class) is obtained. The product images may be obtained by, for example, receiving uploads of images directly from the merchant or by automatically scraping image data from the product webpage.

In operation 404, the streaming media management engine trains a machine learning model using a dataset comprising the product images. The model, trained on the few-shot learning technique, may create vector representations of the product images and build embedding spaces. For example, each image may be fed to a convolutional neural network that outputs embeddings for them. Embedding vectors that are close to each other (based on a metric, such as Euclidean distance) are considered similar. Images of the same product may thus be vectorized and stored in the same embedding space; in this way, images of a given product can be mapped to a specific embedding space by the model.

In operation 406, the streaming media management engine processes video data for the live media stream by parsing the frames of the video through the machine learning model. In particular, the machine learning model vectorizes input video frames and determines the closest embedding space for the input vector. The model can thus identify the specific product shown in the video based on the input video frames. In operation 408, the streaming media management engine identifies a featured first product in the video based on the video analysis by the machine learning model.

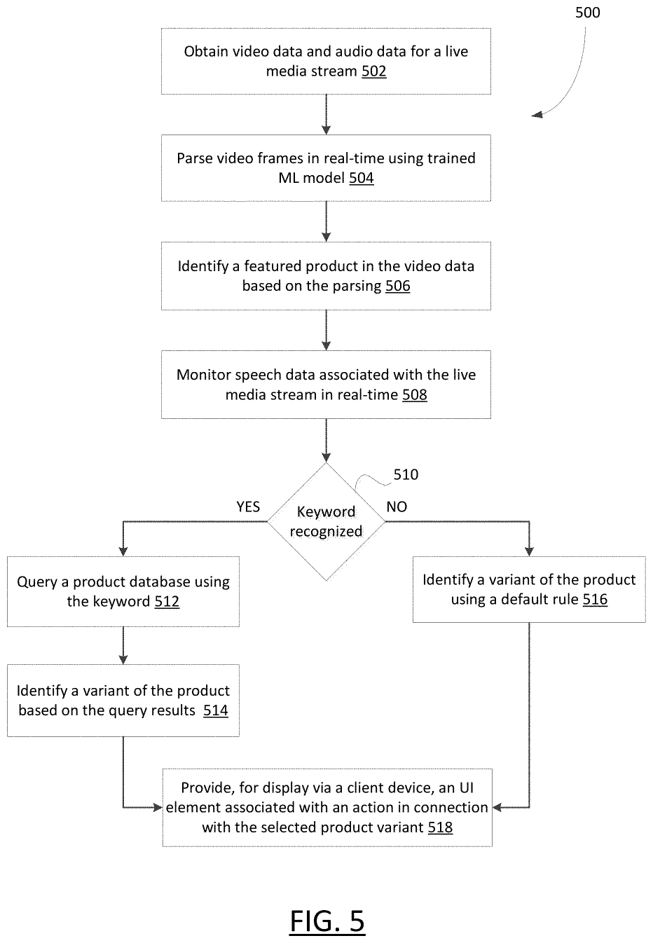

Reference is now made to FIG. 5, which shows, in flowchart form, another example method 500 of controlling a user interface for presenting a live media stream on viewer devices. The method 600 may be performed by a computing system that implements media stream processing, such as the streaming media management engine 210 of FIG. 1. The operations of method 500 may be performed in addition to, or as alternatives of, one or more of the operations of methods 300 and 400.

In operation 502, the streaming media management engine obtains video and audio data for a live media stream. The video and audio data may be received from one or more data sources, such as a broadcaster device. Upon receipt of the stream data, a trained machine learning model associated with the streaming media management engine may be used for parsing video frames of the video in real-time, in operation 504. In particular, a machine learning model trained using a few-shot learning technique may be employed for parsing the video data.

The streaming media management engine then identifies a first product in the video data, in operation 506. The first product may be a product from a catalogue of a merchant associated with the live media stream. Upon identifying the product that is detected in the video analysis, the streaming media management engine monitors audio data associated with the live media stream in operation 508. Specifically, the streaming media management engine performs speech recognition based on utterances that are detected in audio segments following the detected instance of the first product in the video. In at least some embodiments, only those audio segments that are temporally proximal to the video frames featuring the first product may be analyzed for keyword detection. That is, only the keywords that are recognized in speech detected close to the visual featuring of the product may be further processed.

If one or more keywords are recognized in operation 510, the streaming media management engine queries a product database using the keywords in order to determine a specific variant of the first product in operation 512. The database query may include all or a subset of the detected keywords. The streaming media management engine may then select a variant of the first product based on the results of the database query, in operation 514. For example, a product variant that best matches the recognized keywords (e.g., product descriptors) may be selected as the product variant.

If, on the other hand, no keywords are detected in operation 510, this may serve as an indication that the first product may not be available in variants or that no description of variants is provided by the broadcaster. In such cases, the streaming media management engine may identify a variant, if any, using a default rule, in operation 516. For example, the streaming media management engine may query a product database to determine whether any variants of the first product are available. If the first product has variants, one of the available variants may be arbitrarily selected (e.g., random selection) or selected according to certain defined criteria (e.g., most popular or highest selling variant, variant best matching product preferences of the viewer, etc.). For example, the streaming media management engine may access account data associated with the viewer (e.g., a user account at an e-commerce platform) and based on product preference data of the viewer, select one of the variants of the first product.

In operation 518, the streaming media management engine provides, for display via a viewer device, a user interface element associated with an action in connection with the selected product variant.

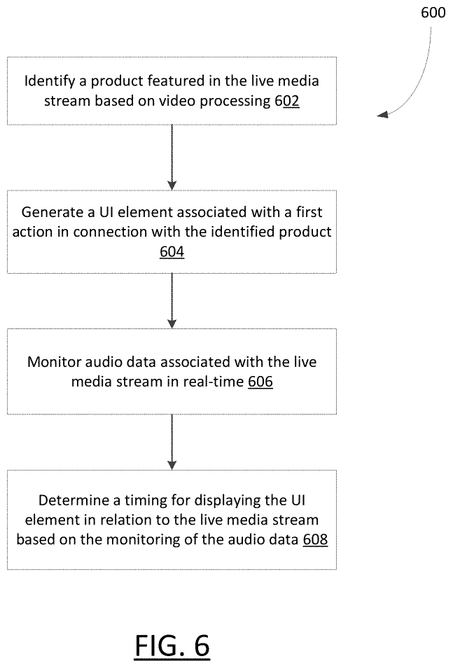

Reference is now made to FIG. 6, which shows, in flowchart form, another example method 600 of controlling a user interface for presenting a live media stream on viewer devices. The method 600 may be performed by a computing system that implements media stream processing, such as the streaming media management engine 210 of FIG. 1. The operations of method 500 may be performed in addition to, or as alternatives of, one or more of the operations of methods 300, 400 and 500.

In at least some implementations, the streaming media management engine may provide user interface control instructions that indicate when to display certain user interface elements during a presentation of a live media stream. For a viewer of a live media stream, it is desirable for relevant product information and actionable user interface elements associated with featured products to be presented to the viewer in real-time. The streaming media management engine may facilitate the display of such information and/or user interface elements on viewer devices by providing control instructions specifying the content items (i.e., user interface element, product data, etc.) and the times at which to display such content items.

The streaming media management engine identifies a product featured in the live media stream based on video analysis, namely video object detection, in operation 602. In operation 604, the streaming media management engine generates a user interface element associated with a first action in connection with the identified product. The streaming media management engine then monitors audio data associated with the live media stream in real-time, in operation 606. The operations 602 to 606 may be performed in a similar manner as the corresponding operations of methods 300 and 500.

In operation 608, the streaming media management engine determines the timing for displaying specific user interface elements in relation to the live media stream. Some user interface elements may be statically or persistently displayed on user interfaces for presenting live media streams. For example, certain input controls (e.g., dropdown lists, buttons), navigation (e.g., sliders, search field) or informational (e.g., tooltips) components associated with the user interfaces may be persistently displayed, irrespective of any products which may be featured in the live media stream. Other user interface elements, such as action buttons (e.g., “Buy Now”, “Visit Product Page”, etc.), may depend on the specific product(s) and/or variants recognized in the video.

In at least some embodiments, the streaming media management engine may cause at least a first user interface element to be displayed, via a user interface on viewer devices, upon initially detecting a featured product in the video. Specifically, the at least first user interface element may be caused to be displayed at a timestamp associated with the video frame in which the featured product is first detected. An interactive button (e.g., “Add to Cart”, “Share Product”, etc.) may be associated with a redirect link for a product page of a featured product. The redirect link may be retrieved, for example, by querying a product database containing product data. Such interactive buttons may be presented via the user interface upon initial detection of the product in the video. For example, the interactive buttons may be caused to be overlayed on top of the video of the live media stream from a time associated with first detection of the featured product. These dynamically generated user interface elements may be displayed for a predetermined length of time or until a defined trigger event, such as the detection of another featured product in the video, recognition of a product variant, etc. Additionally, some user interface elements, such as persistently displayed elements, may be updated when the product is initially detected in the video. For example, a redirect link or functionality associated with a static button on the user interface may be updated with relevant product data for the detected product.

The streaming media management engine may then analyze the audio data associated with the live media stream for at least a predefined (threshold) length of time for recognizing any keywords (or phrases) that are indicative of a possible product variant. If the keywords/phrases allow identification of a variant of the featured product, the streaming media management engine may cause certain ones of the first user interface elements to be updated. Continuing the above example of a button, the redirect link associated with the button may be changed to a different link associated with a product page for the variant. Other types of changes triggered by identification of a specific variant may include, for example, change of label or descriptive text associated with a user interface element, change of appearance or removal of certain interactive overlays, or video effects relating to the product variant.

### Example E-Commerce Platform

Although not required, in some embodiments, the methods disclosed herein may be performed on or in association with an e-commerce platform. An example of an e-commerce platform will now be described.

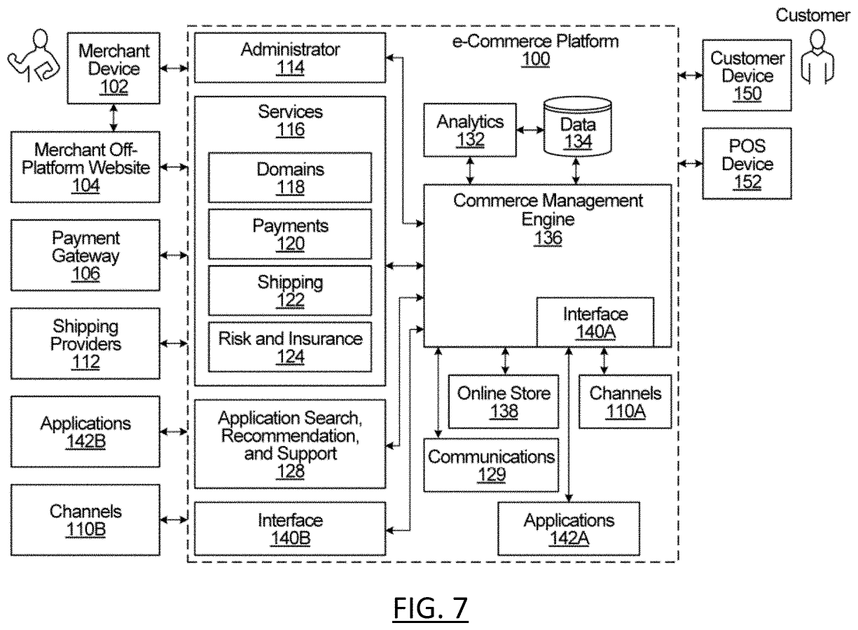

FIG. 7 illustrates an example e-commerce platform 100, according to one embodiment. The e-commerce platform 100 may be exemplary of the e-commerce platform 205 described with reference to FIG. 2. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, additionally or alternatively, be provided by one or more providers/entities.

In the example of FIG. 7, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure, the terms online store and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a transitory memory such as for example, random access memory (RAM), and/or a non-transitory memory such as, for example, a non-transitory computer readable medium such as, for example, persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally, or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

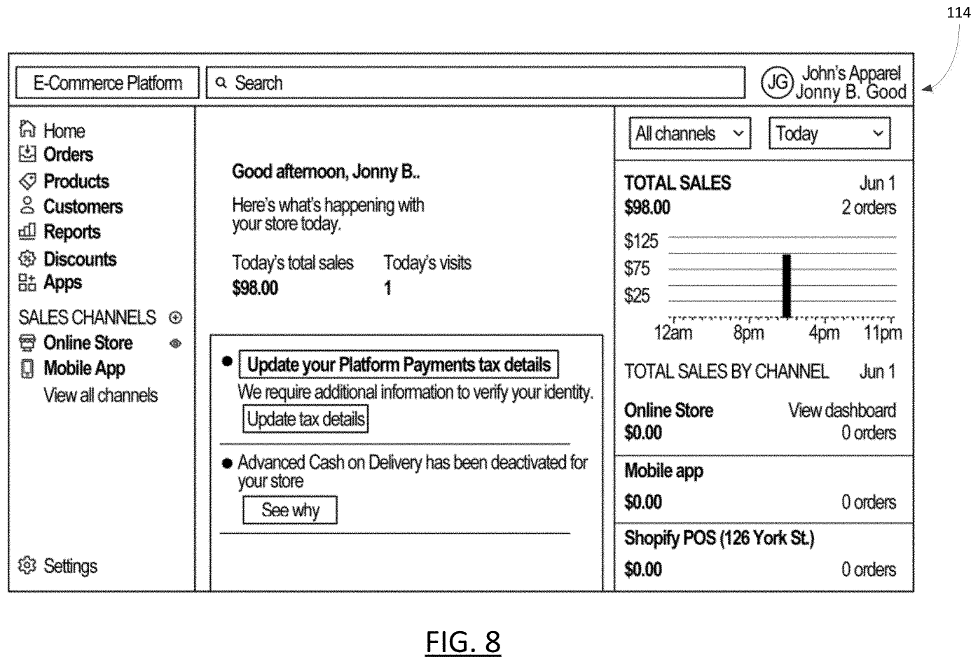

FIG. 8 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 8. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 7, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) to transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and tracks quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method comprising:
obtaining video data and audio data for a live media stream;
detecting a first product in at least one video frame of the live media stream, the first product being one of a first set of defined objects associated with the live media stream;
identify one or more keywords in speech detected in the audio data, the one or more keywords being included in a second set of defined terms associated with the live media stream;
determining a product variant of the first product based on the detected one or more keywords; and
providing, for display via a client device associated with a viewer of the live media stream, an interactive user interface element associated with a first action in connection with the product variant.

2. The method of claim 1, wherein detecting the first product in the at least one video frame comprises processing video frames of the live media stream using a machine learning model.

3. The method of claim 2, wherein the machine learning model is trained using a few-shot learning technique.

4. The method of claim 1, wherein the second set of defined terms comprises a plurality of product descriptors of products.

5. The method of claim 1, wherein determining a product variant of the first product comprises:
determining a candidate set of product variant candidates associated with the first product; and
filtering the candidate set using the detected one or more keywords.

6. The method of claim 1, wherein providing the interactive user interface element associated with the first action comprises:
generating display data associated with the user interface element; and
transmitting the display data to the client device associated with the viewer.

7. The method of claim 1, wherein providing the interactive user interface element associated with the first action comprises at least one of:
updating a graphical representation of the user interface element; or
changing a redirect link that is associated with the user interface element to a new link associated with the product variant.

8. The method of claim 1, wherein identifying the one or more keywords comprises:
obtaining a speech-to-text transcription of the speech detected in the audio data; and
identifying the one or more keywords in the speech-to-text transcription.

9. The method of claim 1, wherein the first action comprises at least one of:
adding the product variant to an online shopping cart associated with the viewer;
processing a purchase of the product variant;
redirecting to a product page associated with the product variant; or
electronically sharing product data for the product variant.

10. The method of claim 1, wherein providing the interactive user interface element comprises causing the user interface element to be overlayed on top of the live video at a first time associated with the at least one video frame.

11. A computing system, comprising:
a processor;
a memory coupled to the processor, the memory storing computer-executable instructions that, when executed, configure the processor to:
obtain video data and audio data for a live media stream;
detect a first product in at least one video frame of the live media stream, the first product being one of a first set of defined objects associated with the live media stream;
identify one or more keywords in speech detected in the audio data, the one or more keywords being included in a second set of defined terms associated with the live media stream;
determine a product variant of the first product based on the detected one or more keywords; and
provide, for display via a client device associated with a viewer of the live media stream, an interactive user interface element associated with a first action in connection with the product variant.

12. The computing system of claim 11, wherein detecting the first product in the at least one video frame comprises processing video frames of the live media stream using a machine learning model.

13. The computing system of claim 12, wherein the machine learning model is trained using a few-shot learning technique.

14. The computing system of claim 11, wherein the second set of defined terms comprises a plurality of product descriptors of products.

15. The computing system of claim 11, wherein determining a product variant of the first product comprises:
determining a candidate set of product variant candidates associated with the first product; and
filtering the candidate set using the detected one or more keywords.

16. The computing system of claim 11, wherein providing the interactive user interface element associated with the first action comprises:
generating display data associated with the user interface element; and
transmitting the display data to the client device associated with the viewer.

17. The computing system of claim 11, wherein providing the interactive user interface element associated with the first action comprises at least one of:
updating a graphical representation of the user interface element; or
changing a redirect link that is associated with the user interface element to a new link associated with the product variant.

18. The computing system of claim 11, wherein identifying the one or more keywords comprises:
obtaining a speech-to-text transcription of the speech detected in the audio data; and
identifying the one or more keywords in the speech-to-text transcription.

19. The computing system of claim 11, wherein the first action comprises at least one of:
adding the product variant to an online shopping cart associated with the viewer;
processing a purchase of the product variant;
redirecting to a product page associated with the product variant; or
electronically sharing product data for the product variant.

20. A non-transitory, computer-readable medium storing computer-executable instructions that, when executed by a processor, configure the processor to:
obtain video data and audio data for a live media stream;
detect a first product in at least one video frame of the live media stream, the first product being one of a first set of defined objects associated with the live media stream;
identify one or more keywords in speech detected in the audio data, the one or more keywords being included in a second set of defined terms associated with the live media stream;
determine a product variant of the first product based on the detected one or more keywords; and
provide, for display via a client device associated with a viewer of the live media stream, an interactive user interface element associated with a first action in connection with the product variant.
